(19) United States
(12) Patent Application Publication
(10) Pub. No.: US 2009/0263612 A1
(43) Pub. Date: Oct. 22, 2009

(54) System and Method for Photobleaching of Optical Media

(75) Inventors: David Gilles Gascoyne, Niskayuna, NY (US); Kwok Pong Chan, Troy, NY (US); Daniel Olson, Bend, OR (US); Marc Brian Wisnudel, Clifton Park, NY (US); Kasiraman Krishnan, Clifton Park, NY (US)

Correspondence Address: GENERAL ELECTRIC COMPANY (PCPI);C/O FLETCHER YODER, P. O. BOX 692289, HOUSTON, TX, 77269-2289, US

(73) Assignee: NBC Universal, Inc., New York, NY (US)

(21) Appl. No.: 12/105,821

(22) Filed: Apr. 18, 2008

(51) Int. Cl. G11B 7/24; C08L 31/00

(52) U.S. Cl. 428/64.4; 524/556

(57) ABSTRACT

A photobleachable ink composition having: at least one light-sensitive optical-state change material; at least one bleaching accelerant; at least one solvent; and at least one binder material; wherein the ink composition has a viscosity between about 0.1 centipoise and about 10,000 centipoise, and a maximum optical absorbance in a range from about 200 nanometers to about 800 nanometers; and wherein the ink composition is capable of change from a first optical state to a second optical state upon exposure to light. The composition may also include a plasticizer.

### BACKGROUND

The present invention relates generally to optical storage devices, such as DVDs and CDs. More specifically, the invention provides optical storage devices on which compositions containing dyes are disposed for facilitating limited or selective use of at least a portion of the content of the optical storage devices.

Portable optical storage devices such as CDs and DVDs have attained a large consumer market in recent years. As such, there has been much effort to improve the technology and for companies to gain a competitive advantage. Along that vein, recently ways have been sought to modify or limit the content, such as by providing limited-play content, to prevent unauthorized copying of the content stored on these devices, and so on. Such issues have been addressed, for example, via the use of dye, phase-change, and other chemical compounds that change their molecular state when irradiated with light.

There is an on-going need to develop an optical storage device, and a method for making it, containing a dye that changes optical properties relatively quickly, that does so under only a few repeated exposures to relatively low intensity energy, that does so at approximately the same wavelength as the energy applied, that does not introduce significant errors to the storage device by its addition thereto. Any one or more of these goals can be attained by the products and methods disclosed herein, as set forth below.

### BRIEF DESCRIPTION

In one embodiment, the present technique provides for a photobleachable ink composition having: at least one light-sensitive optical-state change material; at least one bleaching accelerant; at least one solvent; and at least one binder material; wherein the ink composition has a viscosity between about 0.1 centipoise and about 10,000 centipoise, and a maximum optical absorbance in a range from about 200 nanometers to about 800 nanometers; and wherein the ink composition is capable of change from a first optical state to a second optical state upon exposure to light. The composition may also include a plasticizer.

In one embodiment, the present technique includes a photosensitive ink composition having: at least one photosensitive optical-state change material; at least one additive for accelerating bleaching; at least one solvent; and at least one binder material; wherein the photosensitive ink composition comprises a viscosity between about 0.1 centipoise and about 10,000 centipoise, and a maximum optical absorbance in a range from about 200 nanometers to about 800 nanometers, and wherein the photosensitive ink composition is capable of transforming from a first optical state to a second optical state upon exposure to an optical stimulus. The composition may also include a plasticizer.

In one embodiment, the present technique includes a light-sensitive coating deposited using a light-sensitive ink composition, wherein the coating has: at least one light-sensitive optical-state change material; at least one bleaching accelerant; and at least one binder material; wherein the light-sensitive coating is essentially free of solvent and has a maximum optical absorbance in a range from about 200 nanometers to about 800 nanometers, and wherein the light-sensitive coating is capable of transforming from a first optical state to a second optical state upon exposure to light. The composition may also have a plasticizer.

In one embodiment, the present technique provides for an optical storage device on which at least some limited-use data is stored, the optical storage device including: a storage layer for storing data readable by an optical storage device data reader system; a content access layer covering at least a portion of the data stored on the storage layer and comprising an ink composition comprising a dye compound, wherein the ink composition exhibits a measurable change in optical properties in less than about 10 seconds of exposure to a light source emitting wavelengths from about 200 nm to about 800 nm at an intensity from about 0.5 mW to about 50 mW; and an optically transparent layer through which stored data from the storage layer is accessible. The content access layer may incorporate a bleaching agent.

In one embodiment, the present technique includes an optical storage device, on which at least some limited-use data is stored, the optical storage device having: a storage layer for storing data readable by an optical storage device data reader system; a content access layer covering at least a portion of the data stored on the storage layer, wherein the content access layer comprises a polymethine dye an bleaching agent, and a binder, wherein the polymethine dye exhibits a measurable change in optical properties upon sufficient exposure to one or more characteristic wavelengths of energy; and an optically transparent layer through which stored data from the storage layer is accessible.

The present technique provides a method of fabricating a limited-use optical storage device, including: depositing a photobleachable ink composition comprising at least one light-sensitive optical-state change material, at least one bleaching agent, at least one solvent, and at least one binder material; wherein the ink composition has a viscosity between about 0.1 centipoise and about 10,000 centipoise, and a maximum optical absorbance in a range from about 200 nanometers to about 800 nanometers, and wherein the ink composition is capable of transforming from a first optical state to a second optical state upon exposure to light.

### DRAWINGS

These and other features, aspects, and advantages of the present invention will become better understood when the following detailed description is read with reference to the accompanying drawings in which like characters represent like parts throughout the drawings, wherein:

FIG. 1 is a cross-section perspective of an optical storage device in which a content access layer and an optically transparent layer are added to a pre-fabricated optical storage device in accordance with embodiments of the present technique;

FIG. 2 is a cross-section perspective of an optical storage device in which a content access layer is places between a storage layer and an optically transparent layer in accordance with embodiments of the present technique;

FIG. 3 is a cross-section perspective of an optical storage device having first and second storage layers, in which a content access layer is disposed between the first storage layer and the external surface of the optical storage device that is to be exposed to energy from an optical data reader in accordance with embodiments of the present techniques;

FIG. 4 is a top view perspective of a DVD, as in FIG. 1, where the content access layer is spin-coated onto the pre-fabricated DVD, and a mask was used to photobleach spots on the content access layer in accordance with embodiments of the present technique;

FIG. 5 is a flow chart of a method of fabricating an optical storage device, such as those depicted in FIGS. 1 and 4, in accordance with embodiments of the present technique;

FIG. 6 is a flow chart of a method of fabricating an optical storage device, such as the device depicted in FIG. 2, in accordance with embodiments of the present technique;

FIG. 7 is a plot depicting differences in bleach rate for plasticized ink versus un-plasticized ink in accordance with embodiments of the present technique;

FIG. 8 is a bar chart depicting the bleach rate of ink formulation measured at the initial deposition and after room-temperature aging in accordance with embodiments of the present technique;

FIG. 9 is a bar chart depicting a comparison of the bleach rate of two plasticized inks and a plasticized ink for ink jet printing in accordance with embodiments of the present technique;

FIG. 10 is a plot of bleach rate of an ink formulation as a function of DOP concentration in accordance with embodiments of the present technique; and

FIG. 11 is a plot of bleach rate of an ink formulation versus the mole ratio of borate to HNu-640 cyanine dye in accordance with embodiments of the present technique.

### DETAILED DESCRIPTION

While only certain features of the invention have been illustrated and described herein, many modifications and changes will occur to those skilled in the art. It is, therefore, to be understood that the appended claims are intended to cover all such modifications and changes as fall within the true spirit of the invention.

Embodiments of the present technique incorporate a polymethine dye (e.g., cyanine dye), as an ion-pair with a non-electron donating anion and/or in an ion-pair in which the anion is electron donating such as an electron donating borate anion which can be used as an bleaching accelerant (may also be labeled as a bleaching agent, an additive for accelerating bleaching, and so on). Examples of the present bleaching accelerants may include an electron transfer agents, such as an electron donating borate (e.g. triphenylalkyl borate or diphenylalkylborate), and so on. The bleaching accelerant generally may be an electron transfer agent. Beneficially, exemplary cyanine/borate systems generally bleach much faster than cyanine/anion systems in which the anion is not an electron transfer agent.

In one embodiment, the bleaching accelerant is an anion with the following generic formula:

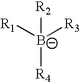

and R1, R2, R3, R4 independently represent an alkyl, aryl, alkaryl, allyl, alkenyl, alkynyl, heterocyclic, substituted alkyl, or substituted aryl group.

The present technique consists of a formulation of a photobleachable ink which contains a plasticizer. The plasticizer may increase the speed with which the ink photobleaches when exposed to light. In certain embodiments, the photobleachable ink may be applied to a DVD that is authored to play certain video content when the ink is in it's “unbleached” state but skip over the content when the ink is in it's “bleached” state.

The identified solvent compositions generally dissolve the ink components and facilitate printing of the ink on the DVD substrate. Further, the present technique may includes solvent compositions that can dissolve most or all of the ink components. Also, the solvent compositions are generally compatible with the printing processes used to apply the ink to the DVD substrate (e.g. polycarbonate). Again, the present technique may include the addition of a plasticizer to increase the bleach rate of a photosensitive ink.

It should be emphasized that while the present discussion may at times focus on limited-play DVDs, the present technique is applicable to optical articles, in general, and for a variety of applications other than limited-play.

In general, the present limited-play ink compositions may include at least one photosensitive optical-state change material, at least one additive for accelerating the bleaching (also may be labeled bleaching agent, bleaching accelerant, etc.), at least one solvent, and at least one binder material. The composition may have a viscosity between about 0.1 cPs and about 10,000 cps, which may facilitate the printing of the ink on the DVD. The compositions may have a maximum optical absorbance in a range from about 200 nm to about 800 nm, and when exposed to an optical stimulus having light of such a range, the photosensitive ink composition (may also be labeled light-sensitive ink) is capable of transforming from a first optical state to a second optical state.

The term “photosensitive” as used herein, describes materials that undergo either a reversible or an irreversible light induced color change. As used herein the term “optical-state change” material is used to describe a material which is capable of existing in at least two different forms, each form possessing a unique optical state, for example a unique wavelength associated with a maximum optical absorbance within a range from about 200 nm to about 800 nm, or a unique extinction coefficient at a specific wavelength between about 200 nm to about 800 nm. Non-limiting examples of photosensitive optical-state change materials include various dyes and pigments that respond to different wavelengths of light.

In various embodiments, the solvents used in the photosensitive ink compositions are selected based on different parameters as discussed herein. For example, a suitable solvent may be selected to satisfy the solubility of various components in the photosensitive ink composition including the binder material, the photosensitive optical-state change material, and the additive for accelerating the bleaching. In other examples, wherein the photosensitive ink composition is used to deposit a photosensitive coating composition, the solubility of the different components of the photosensitive ink composition in the solvent should be such that there will be no phase separation of the different components during the post-deposition drying step.

In other instances, where the photosensitive ink composition is used to deposit a photosensitive coating composition on an article, applicable solvents may include those that exhibit a chemical inertness towards the material used to form the article. For example if the article is an optical article such as for example a DVD made using a polycarbonate, the selected solvent(s) should not induce solubilization, crystallization, or any other form of chemical or physical attack of the polycarbonate. This is beneficial to preserve the readability of the data underneath the photosensitive coating composition. In some applications where the ink is printed on a substrate it may be beneficial to have a solvent mixture in which a portion of the mixture interacts with the substrate to provide good adhesion between the substrate and the ink. For example, when ink is printed on polycarbonate it may be useful to employ a solvent mixture in which part of the solvent mixture partially dissolves the polycarbonate substrate to create a strong adherence of the ink to the substrate. In the case of solvent mixtures, the volume fraction of any solvent that could potentially attack the polycarbonate may be less than about 50 percent. As used herein the term “surface tension” refers to a property of the liquid that affects the spreading of a liquid on a surface. The surface tension will have a dramatic result on the final shape of a drop or multiple drops of liquid printed on solid surfaces. With respect to the ink formulations of the present disclosure, surface tension may be an important (or even critical) parameter for printing the ink formulations using conventional printing techniques such as inkjet printing, screen printing, and so on. Surface tension is also a parameter for the jetting process itself during inkjet printing, as it will affect how drops are formed at the print-head. If the surface tension is not appropriate, inks will not jet properly with inkjet printing.

Other aspects of the present solvents may include low vapor pressure and high boiling points, such that the photosensitive ink is printable by methods known to one skilled in the art (e.g., screen printing or ink-jet printing techniques). Unfortunately, solvents with lower boiling points may evaporate rapidly from the ink, causing clogging of inkjet print head nozzles or drying onto a printing screen, either of which can lead to poor quality of the resultant photosensitive coating. Thus, solvents presently employed may have a boiling point above 130° C. are preferred.

Solvents employed in the photosensitive ink composition may include, but are not limited to: a glycol ether solvent, an aromatic hydrocarbon solvent containing at least 7 carbon atoms, an aliphatic hydrocarbon solvent containing at least 6 carbon atoms, a halogenated solvent, an amine based solvent, an amide based solvent, an oxygenated hydrocarbon solvent, or miscible combinations thereof. Some specific non-limiting examples of such solvents include 4-Hydroxy-4-methyl-2-pentanone (diacetone alcohol), dipropylene glycol methyl ether (Dowanol DPM), butyl carbitol, ethylene glycol, glycerol with glycol ethers, cyclohexanone, or any miscible combinations thereof.

A function of the binder materials is to assist the adherence of a photosensitive ink composition to the surface of an article on which the photosensitive ink composition is deposited. Suitable non-limiting examples of binder materials include one or more of a polymer, an oligomer, a polymeric precursor, and a polymerizable monomer. Suitable non-limiting examples of polymeric materials include poly(alkenes), poly(anilines), poly(thiophenes), poly(pyrroles), poly(acetylenes), poly(dienes), poly(acrylates), poly(methacrylates), poly(vinyl ethers), poly(vinyl thioethers), poly(vinyl alcohols), poly(vinyl ketones), poly(vinyl halides), poly(vinyl nitriles), poly(vinyl esters), poly(styrenes), poly(arylenes), poly(oxides), poly(carbonates), poly(esters), poly(anhydrides), poly(urethanes), poly(sulfonates), poly(siloxanes), poly(sulfides), poly(thioesters), poly(sulfones), poly(sulfonamides), poly(amides), poly(ureas), poly(phosphazenes), poly(silanes), poly(silazanes), poly(benzoxazoles), poly(oxadiazoles), poly(benzothiazinophenothiazines), poly(benzothiazoles), poly(pyrazinoquinoxalines), poly(pyromellitimides), poly(quinoxalines), poly(benzimidazoles), poly(oxindoles), poly(oxoisoindolines), poly(dioxoisoindolines), poly(triazines), poly(pyridazines), poly(piperazines), poly(pyridines), poly(piperidines), poly(triazoles), poly(pyrazoles), poly(pyrrolidines), poly(carboranes), poly(oxabicyclononanes), poly(dibenzofurans), poly(phthalides), poly(acetals), poly(anhydrides), carbohydrates, blends of the above polymeric materials, and copolymers thereof. In one embodiment, the photosensitive ink composition comprises a polymerizable monomer, such as an acrylate monomer (e.g., methyl methacrylate), which can be polymerized (i.e. cured) to form a photosensitive coating after the photosensitive ink composition has been deposited on an optical article.

As described herein, the term “photosensitive ink composition” is used to describe a liquid composition comprising various components as described above. In one embodiment, the photosensitive ink composition has a viscosity in a range from about 0.1 cPs to about 10,000 cps. In various embodiments, the viscosity of the photosensitive ink composition may be tuned by controlling the concentration, such as for example the weight percent of the various components of the photosensitive ink composition, and/or by carefully controlling a particular property of a specific component of the photosensitive ink composition such as for example the molecular weight of the binder material.

In one embodiment, the difference in the optical reflectivity of the ink composition between the first optical state and the second optical state is at least 10 percent. In yet another embodiment, the difference in the percent transmittance of the photosensitive optical-state change material between the first optical state and the second optical state is at least 10 percent.

In one example, the photosensitive ink composition has a maximum optical absorbance in a range of about 200 nm to about 800 nm. It will be appreciated that the specific wavelengths for which the absorbance of the composition is maximized may be chosen to correspond to a particular application. For instance, if the composition is intended for use with DVD systems, the choice of wavelength should desirably correspond to the wavelengths in use in DVD players.

The present technique may provide a photosensitive coating composition, deposited using a photosensitive ink composition, wherein the photosensitive coating composition comprises at least one photosensitive optical-state change material, at least one additive for accelerating the bleaching, and at least one binder material, wherein the photosensitive coating composition is essentially free of solvent, wherein the photosensitive coating composition has a maximum optical absorbance in a range from about 200 nm to about 800 nanometers, and wherein the photosensitive coating composition is capable of transforming from a first optical state to a second optical state upon exposure to an optical stimulus. In yet another embodiment, the present invention provides an article comprising photosensitive coating composition deposited in or deposited on the article.

As used herein, the term “coating” describes a layered film structure. In certain embodiments, the layered film structure may comprise a single layer. In one embodiment, the thickness of the coating is in a range from about 0.1 micron to about 100 microns.

In one embodiment, the photosensitive coating composition may be deposited on an article using the photosensitive ink composition by employing methods known to one skilled in the art. For example, screen printing and ink-jet printing methods can be used. In one embodiment, the article is an optical article. Subsequent to printing, the photosensitive ink composition may be converted to the corresponding photosensitive coating composition through an additional drying step, using methods known to one skilled in the art. Exemplary methods include air drying at ambient conditions, drying under controlled temperature conditions such as for example in an oven, drying under vacuum, and the like.

As used herein, the term “essentially free of solvent” means that the photosensitive coating composition may contain less than about 0.1 weight percent of solvent based on the total weight of the photosensitive coating composition.

In various embodiments for photosensitive coating composition, the photosensitive optical-state change material, the additive for accelerating the bleaching, the binder material, the plasticizer may be the same or similar to those discussed above for the photosensitive ink composition.

In one embodiment, the photosensitive coating composition has a maximum optical absorbance in a range of about 200 nm to about 800 nm. In another embodiment, the photosensitive coating composition has a maximum optical absorbance in a range of about 300 nm to about 700 nm. In yet another embodiment, the photosensitive coating composition has a maximum optical absorbance in a range of about 400 nm to about 650 nm. As discussed above, it will be appreciated that the specific wavelengths for which the absorbance of the composition is maximized may be chosen to correspond to a particular application.

As used herein, the term “optical article” refers to an article that includes an optical data layer for storing data. The stored data may be read by, for example, an incident laser of an optical data reader device such as a standard compact disc (CD) or digital versatile disc (DVD) drive, commonly found in most computers and home entertainment systems. In some embodiments, the optical article may include one or more data layers. Furthermore, the optical data layer may be protected by employing an outer coating, which is transparent to the incident laser light, and therefore allows the incident laser light to pass through the outer coating and reach the optical data layer. Non-limiting examples of optical articles include: a compact disc (CD); a digital versatile disc (DVD); multi-layered structures, such as DVD-5 or DVD-9; multi-sided structures, such as DVD-10 or DVD-18; a high definition digital versatile disc (HD-DVD); a Blu-ray disc; a near field optical storage disc; a holographic storage medium; and a volumetric optical storage medium, such as, a multi-photon absorption storage format.

In one embodiment, when the photosensitive ink composition or the photosensitive coating composition is in the first optical state the optical article may be considered to be in a pre-activated state of functionality and when the photosensitive ink composition or the photosensitive coating composition is in the second optical state the optical article may be considered to be in an activated state of functionality. In one embodiment, the difference in the percent optical reflectivity or the percent transmittance of at least one portion of the optical data layer in the “pre-activated state” of functionality and the “activated” state of functionality is at least about 10 percent. In another embodiment, the difference in the percent optical reflectivity or the percent transmittance of at least one portion of the optical data layer in the “pre-activated state” of functionality and the “activated” state of functionality is at least about 25 percent. In yet another embodiment, the difference in the percent optical reflectivity or the percent transmittance of at least one portion of the optical data layer in the “pre-activated state” of functionality and the “activated” state of functionality is at least about 50 percent.

In various embodiments, the optical article comprising the photosensitive coating composition may be transformed from a “pre-activated” state of functionality to an “activated” state of functionality. Conversion from the “pre-activated” state of functionality to the “activated” state of functionality is achieved by the activation of the photosensitive coating composition, which is deposited in or on the optical article, such that the photosensitive coating composition is in optical communication with the optical data layer. As used herein, the term optical communication refers to transmission and reception of light by optical devices. The photosensitive coating composition is activated by interacting with one or more optical stimuli, applied either directly or remotely to the photosensitive coating composition. In one embodiment, the photosensitive coating composition is capable of irreversibly altering the state of functionality of the optical article. In the “pre-activated” state, at least one portion of the data from the optical data layer is unreadable by the incident laser of an optical data reader device, however, this same portion of data can be read from the optical data layer in the “activated” state of functionality.

As used herein, the term “pre-activated” state of functionality refers to a state of functionality of the optical article where the photosensitive coating composition has not yet been exposed to one or more external stimuli, while the “activated” state refers to a state of functionality where the photosensitive coating composition has been exposed to the external stimuli.

In certain examples, the pre-activated and activated states are linked with an “authoring” component on the DVD, which allows the disc to play certain video content or not play the content, depending on whether portions of the data on the optical data layer can be read by the incident laser from an optical data reader. An explanation of the term “authoring” as it relates to an optical article, such as a DVD, can be found in “DVD Authoring and Production”, by Ralph LaBarge, CMP Books, 2001. In this second approach, the photosensitive coating composition is at least partially opaque to the incident laser from an optical data reader in the “pre-activated” state, and the data directly in the optical path of the laser cannot be read. In this instance, the optical article is “authored” to play certain content. Upon converting the optical article to the “activated” state using an external stimulus, the photosensitive coating is at least partially transparent to the incident laser, the data directly in the optical path of the laser can be read, and the disc is “authored” to skip certain content.

Alternatively, instead of being deposited on the surface of the optical article, the photosensitive coating composition may be deposited inside the structure of the optical article. In optical storage articles, the photosensitive coating composition may be deposited in the substrate on which the optical data layer is deposited. In such an embodiment, the photosensitive coating composition may be mixed with the substrate material of the optical article. In alternate embodiments, the photosensitive coating composition may be deposited between the layers of the optical article, or may be deposited within the layers of the optical article. For example, the photosensitive coating composition may be incorporated in the UV curable adhesive of the bonding (spacer) layer. Also, these photosensitive coating compositions may preferably absorb the wavelength of the laser in one of the activated, or the pre-activated states of the optical article. Upon interaction with external stimulus, the photosensitive coating composition present inside the substrate changes color. As a result, the substrate may become transparent to the laser light, thereby facilitating the transmittance of laser light through the substrate.

In some embodiments, at least a portion of the photosensitive coating composition is coated with an optically transparent second layer. The optically transparent second layer serves as a protective coating for the photosensitive coating composition from chemical and/or physical damage. The optically transparent second layer may contain cross-linkable materials that can be cured using ultraviolet (UV) light or heat. Furthermore, the optically transparent second layer may be a scratch resistant coating. For example, the optically transparent second layer may include, but is not limited to, a matrix consisting of cross-linkable acrylates, silicones, and nano or micron silicate particles. Suitable examples of an optically transparent second layer can be found in U.S. Pat. No. 5,990,188.

Optical storage devices, as described herein, are typically those that store information capable of being accessed using optical data reader systems including light sources such as visible lasers, UV lasers, infrared lasers, or the like, and detectors thereof. As used herein, the term “optical”, with reference to optical storage devices and optical data reader systems, means that the information stored thereon and/or retrieved thereby utilizes wavelengths from about 100 nm to about 1 micron, preferably from about 200 nm to about 850 nm. In certain embodiments, the term “optical” refers to wavelengths of light that are visible to the human eye, or those from about 370 nm to about 800 nm.

While the optical storage devices described herein generally involve optical storage and are typically in read-only format, the invention is not limited thereto, as, e.g., writable and/or re-writable format optical storage devices may also be used. Examples of optical storage devices, as described herein, can include, but are not limited to, DVDs such as DVD-5, DVD-9, DVD-10, DVD-14, and DVD-18, CDs, laser discs, HD-DVDs, Blu-ray discs, magneto-optical, UMD, volumetric storage media such as holographic media and the like, including pre-recorded, recordable, and rewriteable versions of such formats.

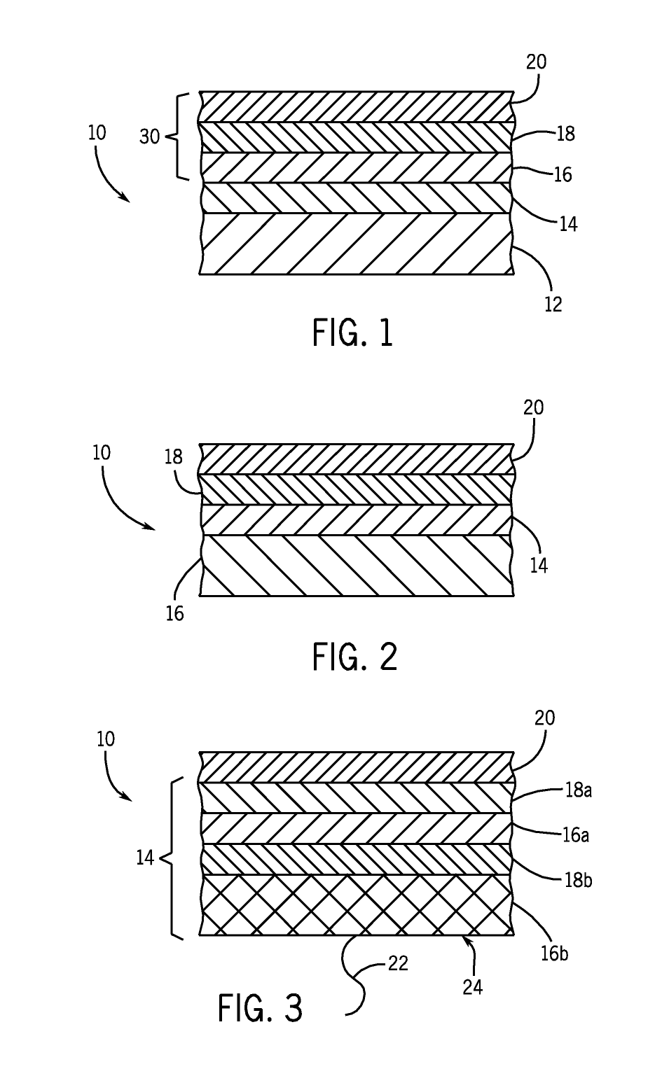

Storage layers, such as storage layer 18 (FIG. 1), in most optical storage devices are relatively consistent. For instance, in CDs and DVDs, a reflective layer is the storage layer and typically includes a series of bumps/pits that correspond to data. This data can be read by data reader systems, e.g., optical readers, where a laser light of a given wavelength (e.g., about 405 nm for HD-DVD and Blu-ray discs, about 635-650 nm for DVDs, and about 780 nm for CDs) is reflected off the surface of the storage layer to a detector keyed to receive the given wavelength of light, for instance, as the storage device is rotated. The bumps reflect the light differently than the other portions of the storage layer, and the pattern of those different reflections of light encodes the stored data.

In the case of conventional CDs and DVDs, the storage layer typically contains or is made from a reflective metallic material like aluminum. As shown in FIG. 1, disposed on opposite sides of storage layer 18 are a first layer 20 (e.g., typically an acrylic resin and/or polycarbonate substrate) that primarily protects the storage layer and a second layer 16 (e.g., typically a polycarbonate) which is substantially transparent to the given wavelength of light and thus through which the light from the optical reader is applied and reflected, and which can also function as another protective layer for storage layer 18. In some cases, there can be multiple storage layers on a single side of the substrate, back-to-back storage layers, bonding/adhesive layers, and/or additional optically transparent layers. Collectively, first or coating layer 20, storage layer 18, and second or optically transparent layer 16, as shown in FIG. 1, can represent the structure a conventional single-sided CD or DVD (30).

As shown in FIGS. 1-2, content access layer 14 can be disposed anywhere on optical storage device 10 between storage layer 18 and the data reader system energy (light) source. For instance, in FIG. 2, content access layer 14 is disposed between storage layer 18 and optically transparent layer 16, while in FIG. 1 content access layer 14 is disposed between the data reader system energy source and optically transparent layer 16, or both. In one preferred embodiment, based on FIG. 1, content access layer 14 is disposed on optically transparent layer 16 and thus between optically transparent layer 16 and the data reader system energy source (not shown). In another preferred embodiment, shown in FIG. 1, content access layer 14 is disposed between optically transparent layer 16 (disposed on storage layer 18) and a second optically transparent layer 12 that is disposed on an outermost surface of optical storage device 10 and can function to protect content access layer 14.

One aspect of the invention, shown in FIG. 2, is an optical storage device (10), such as a CD or a DVD, on which at least some limited-use data is stored and comprising storage layer 18 on which data is stored, content access layer 14 covering at least a portion of the data stored on the storage layer, coating layer 20 capable of protecting the storage layer and thus the data thereon, and, optionally but preferably, an optically transparent layer (16) through which the stored data from the storage layer can be accessed. In most embodiments, optically transparent layer 16 also functions as a protective layer but is disposed on a side of storage layer 18 opposite from the side on which coating layer 20 is disposed. In one embodiment, content access layer 14 and optically transparent layer 16 are combined to form a single optically transparent content access layer.

In another embodiment, shown in FIG. 3, an optical storage device (10), such as a DVD-9, on which at least some limited-use data is stored and comprising two storage layers 18a, 18b on which data is stored, two optically transparent layers 16a, 16b through which the stored data from storage layers 18a, 18b can be accessed, coating layer 20 capable of protecting the storage layers and thus the data thereon, and content access layer 14 covering at least a portion of the data stored on at least one of the storage layers. Although content access layer 14 is shown in FIG. 3 to be disposed between storage layer 18b and optically transparent layer 16b, this is merely one embodiment. Content access layer 14 can be disposed anywhere in optical storage device 10 between storage layer 18a and the energy-incident surface 24 of the most external optically transparent layer 16b. Content access layer 14 can be its own layer or can be coterminous, co-formed, or mixed together with one or more of optically transparent layers 16a, 16b. Wavelengths of energy 22 from optical storage device data reader system (not shown) can be used to access the data stored on storage layers 18a, 18b, at least some of which data can be covered by content access layer 14.

Content access layer 14, as described herein, may include an ink composition, which includes, but is not limited to: one or more dye compounds that exhibit a change in optical properties (e.g., photobleaching) upon exposure for a sufficient time and at a sufficient intensity to one or more wavelengths of energy (light) typically emitted by optical storage device data reader systems discussed above; a diluent/solvent; an oligomeric/polymeric binder/viscosity enhancer; optionally an bleaching accelerant for the dye compound (e.g., an electron donor, a dye compound bleaching activator, or the like, or a combination thereof); and other optional components known in the art, such as dispersants, salts, or the like, or combinations thereof.

The dye compound, as described herein, can be tailored to the specific wavelength of energy (light) typically emitted by the particular optical storage device data reader system; i.e., a dye compound for use on a DVD should exhibit a significant change in optical properties upon sufficient exposure to wavelengths of about 635-650 nm, while a dye compound for use on a HD-DVD or Blu-ray disc should exhibit a significant change in optical properties upon sufficient exposure to wavelengths of about 405 nm, and a dye compound for use on a CD should exhibit a significant change in optical properties upon sufficient exposure to wavelengths of about 780 nm. Examples of general classes of dye compounds meeting such requirements may include polymethines (e.g., cyanines), triarylmethanes, xanthenes, thiazines, oxazines, lactones, fulgides, spiropyrans, and diarylethenes. Examples of such dye compounds can include, but are not limited to, methylene blue, toluidine blue, Rose Bengal, erythrosine B, eosin Y, fluorone dyes, and those dyes and photoinitiators disclosed in U.S. Pat. Nos. 5,451,343 and 5,395,862, and in International Publication No. WO 97/21737.

In one embodiment, the dye compound contains a polymethine dye having the following generic formula:

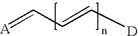

In another embodiment the dye compound contains a cyanine cation having the following generic formula:

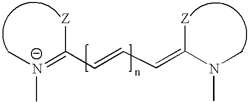

In another embodiment the dye compound contains a cyanine cation having the following formula:

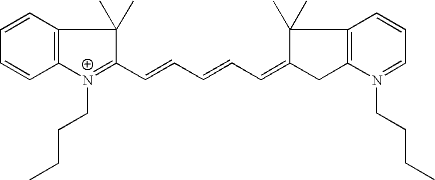

The change in optical properties of the dye compound/composition upon exposure to the energy source, e.g., from the optical data reader system for the particular optical storage device, can appear in any manner that results in the optical data reader system receiving a substantial change in the amount of energy detected. For example, where the dye is initially opaque and becomes more transparent upon exposure, there should be a substantial increase in the amount of light reflected off of the storage layer and transmitted through the content access layer and the optional optically transparent layer. Most dye compounds typically change (reduce) the amount of incident radiation detected by means of selective absorption at one or more given wavelengths of interest (corresponding to the type of optical storage device data reader system energy source). However, energy absorbance by the dye compound is not the only way to effect an optical property change.

Most types of optical storage device data reader system detectors are specifically designed to detect at least a certain intensity of radiation, reflected at a narrow set of wavelengths and/or frequencies surrounding the emitted wavelength(s) and/or frequency(ies), and usually in a particular polarization state. Therefore, besides absorbing the incident energy wavelength(s), the dye compound(s) and/or the ink composition may additionally or alternately accomplish any one or more of the following: change the polarization state of the incident energy; alter the frequency/wavelength of the incident energy; change the path of the incident energy, whether through reflection, refraction, scattering, or other means such that some portion of the energy is directed (and/or reflected off of the storage layer) away from the optical storage device data reader system detector.

For instance, in DVD-5 optical readers, the detector will typically read an error at least about 90% of the time when less than about 20% of the incident laser light reaches the detector, and the detector will typically read an error at least about 99% of the time when less than about 10% of the incident laser light reaches the detector. However, the detector will also typically read an error less than about 2% of the time when at least about 45% of the incident laser light reaches the detector. Thus, any dye compound/composition that can be alternated between these extremes of opacity and transparency at the given incident wavelength(s) upon exposure to energy of the same incident wavelength(s) is appropriate for use in content access layers, as described herein. Nevertheless, it is preferable to use dye compounds that are not threshold dye compounds for the incident energy wavelength(s). As used herein, “threshold dye compounds” mean dye compounds that do not exhibit a change in optical properties even upon repeated low-intensity exposure to incident energy at wavelength(s) typically emitted by conventional optical storage device data reader systems (e.g., from about 1 mW to about 50 mW for both CDs and DVDs). Without being bound to theory, it is believed that a threshold dye compound may experience desirable changes in optical properties upon exposure to incident energy of an intensity significantly higher (e.g., at least a factor of three higher, preferably at least a factor of five higher, and in some cases at least a factor of seven higher) than that emitted by current conventional optical storage device data reader systems at the given wavelength(s). As an example, the phthalocyanine and naphtholocyanine dyes disclosed in U.S. Patent Application Publication No. 2003/0081521 A1 are such threshold dyes, requiring an exposure at about 650 nm of more than 50 mW in intensity in order to bleach, and even then, those materials have been found instead to absorb energy at different wavelengths (on the order of about 700 nm, instead of the wavelength, about 650 nm, to which they were exposed).

The relative amount of dye compound in the ink composition of the content access layer will generally depend, at least in part, upon the initial opacity/color of the dye compound, the extent to which the dye compound changes optical properties (e.g., transparency/reflectivity) upon exposure to energy, and/or the thickness of the content access layer. In one embodiment, the ink composition can contain one or more dye compounds in a total amount ranging from about 0.01% to about 10% by weight, from about 0.1% to about 6% by weight, or from about 0.5% to about 5% by weight, for example from about 0.2% to about 3% by weight. In an alternate embodiment, the ink composition can contain one or more dye compounds in a total amount ranging from about 0.5 wt % to about 8%. In another alternate embodiment, the ink composition can contain one or more dye compounds in a total amount ranging from about 0.05% to about 0.5% by weight.

The use of a bleaching accelerant with the dye compound is generally beneficial, e.g., to decrease the applied energy intensity and/or exposure time necessary to effect the change in optical properties of the dye compound. Optical dye activators used in the content access layers, as described herein, can be tailored to the particular dye compound and/or ink composition. Examples of bleaching accelerants, as described herein, may include, but are not limited to, trifunctional amines such as triethanolamine, triethanolamine triacetate, N,N-dimethylethylamine (DMEA), N,N-dialkylanilines such as N,N-dibutylaniline and DIDMA (N,N-dimethyl-2,6-diisopropylaniline), ethyl-para-(dimethylamino)benzoate, octyl-para-(dimethylamino)benzoate, 4-diethylamino-o-tolualdehyde, ETQC (3-[(1-ethyl-1,2,3,4-tetrahydro-6-quinolinyl)methylene]-2,3-dihydro-4H-1-benzopyran-4-one), DEAW (2,5-bis[[4-(diethylamino)phenyl]methylene]-(2E,5E)-cyclopentanone), 4,4′,4″-methylidynetris[N,N diethyl-3-methyl-benzenamine], and the like, and combinations thereof; difunctional amines such as diethanolamine, n-phenylglycine, lophine monomer (2,4,5-triphenyl-1,3-imidazole) or dimer, 2-mercaptobenzoxazole, and the like, and combinations thereof; monofunctional amines such as ethanolamine, aniline, and the like, and combinations thereof; photoinitiators such as 1,4,4-trimethyl-2,3-diazabicyclo[3.2.2]non-2-ene-2,3-dioxide; acrylate (polyester) amines such as those sold under the tradename EBECRYL™; borate; Borate V (butyrylcholine triphenyl-n-butyl borate); borate salts such as n-butyrylcholine triphenyl-n-butyl borate, tetramethylammonium triphenylbutyl borate, tetramethylammonium trianisylbutyl borate, n-butyrylcholine dialkyldiphenyl borate, n-butyrylcholine alkyltriphenylborate, tetramethylammonium trianisyloctyl borate, and the like, and combinations thereof; iodonium salts such as OPPI ([4-(octyloxy)phenyl]phenyl-iodonium hexafluoroantimonate), bis(4-tert-butylphenyl)-iodonium triflate, (4-methoxyphenyl)-phenyliodonium triflate, (4-methylphenyl)-phenyliodonium triflate, DDPI (dodecyldiphenyliodonium hexafluoroantimonate), (4-(2-tetradecanol)-oxyphenyl)iodonium hexafluoroantimonate, and the like, and combinations thereof; and the like; reaction/decomposition products thereof; and combinations thereof. Other useful bleaching accelerants can include, e.g., those disclosed in U.S. Pat. Nos. 5,451,343 and 5,166,041, as well as U.S. Patent Application Publication No. 2004/0152017 A1, the disclosures of each of which are hereby incorporated by reference.

When present, the relative amount of bleaching accelerant in the content access layer will generally depend, at least in part, upon the chemical nature of the dye compound, the relative amount of the dye compound, the initial opacity/color of the dye compound, the thickness of the content access layer, and/or the extent to which, and/or the speed with which, the dye compound changes transparency/reflectivity upon exposure to energy. In one embodiment, the content access layer contains one or more bleaching accelerants in a total amount ranging from about 0.1% to about 35% by weight, preferably from about 0.5% to about 25% by weight, more preferably from about 1% to about 15% by weight, for example from about 0.5% to about 9% by weight. In an alternate embodiment, the content access layer contains one or more bleaching accelerants in a total amount ranging from about 3% to about 12% by weight, preferably from about 2.5% to about 10% by weight. In another embodiment, the content access layer contains one or more bleaching accelerants such that the weight ratio of bleaching accelerants to dye compounds ranges from about 1:2 to about 30:1, preferably from about 1:1 to about 20:1, more preferably from about 3:1 to about 15:1, for example from about 5:1 to about 13:1.

In one example, the content access layer may contain one or more dyes or pigments as a colorant in addition to the ink composition. In this case, the color of these dyes or pigments may remain as the ink composition is bleached by exposure to the drive laser.

As with the optional bleaching accelerants, the optional oligomeric/polymeric binder/viscosity enhancer(s), as described herein, can be tailored to the particular ink composition used in the content access layer. Examples of oligomeric/polymeric binder/viscosity enhancers can include, but are not limited to, polyacrylates such as oligomeric methyl methacrylates (e.g., Elvacite® 2008, commercially available from Lucite), poly(methyl methacrylate)s and/or ammonio methacrylates (e.g., those polymers and copolymers sold under the tradename EUDRAGIT®), poly(alkyl acrylate)s such as poly(methyl acrylate)s, poly(alkacrylate)s, poly(alkyl alkacrylate)s such as poly(ethyl methacrylate), poly(hydroxyalkyl acrylate)s, poly(hydroxyalkyl alkacrylates such as poly(2-hyroxyethyl methacrylate), and the like; poly(vinyl alcohol) and/or oligomeric vinyl alcohols; styrenics, including polystyrene, poly(hydroxystyrene)s, poly(styrene sulfonate)s, and copolymers thereof, such as styrene/butyl methacrylate copolymer, styrene/acrylonitrile copolymer, styrene/allyl alcohol copolymer, and styrene/maleic anhydride copolymer; poly(vinylpyrrolidone)s; poly(vinyl acetate); polyacetals such as poly(vinyl butyral); cellulosics, including hydroxyalkyl celluloses such as hydroxypropyl cellulose, hydroxyalkyl alkylcelluloses such as hydroxypropyl methylcellulose, and the like, as well as partially or completely esterified analogs thereof; and combinations or copolymers thereof.

In some embodiments, the binder material is or includes polymethylmethacrylate (PMMA), which can be of various molecular weights, such as in the range of 5,000 to 2,000,000. For ink-jet printing of the ink composition, the binder material may include PMMA having exemplary molecular weights in the range of about 5,000 to about 100,000, about 10,000 to about 40,000, and so on. For screen printing of the ink composition, the binder material may include PMMA in the range of about 30,000 to about 2,000,000, about 100,000 to about 1,000,000, and the like.

The optional oligomeric/polymeric binder/viscosity enhancer(s), as described herein, may be present in any amount sufficient to allow satisfactory fabrication of the content access layer by techniques known in the art for depositing materials onto substrates. In one embodiment where the ink composition is spin-coated to form the content access layer, the ink composition can contain one or more oligomeric/polymeric binder/viscosity enhancers in a total amount ranging from about 3% to about 35% by weight, preferably from about 5% to about 25% by weight, for example from about 10% to about 20% by weight. In another embodiment where the ink composition is deposited by print-on-demand techniques such as ink-jet printing to form the content access layer, the ink composition can contain one or more oligomeric/polymeric binder/viscosity enhancers in a total amount ranging from about 0.5% to about 10% by weight, preferably from about 1% to about 5% by weight.

As with the optional oligomeric/polymeric binder/viscosity enhancer(s) and the optional bleaching accelerants, the optional diluent(s), as described herein, can advantageously be tailored to the particular ink composition used in the content access layer. Preferably, the diluent(s) used should not include those that significantly detrimentally affect the optical performance characteristics and/or the physico-chemical performance characteristics (e.g., uniformity, mechanical strength, etc.) of the optically transparent layer(s). As used herein, the phrase “significantly detrimentally affect,” in reference to a property, means negatively affect (in this case, decrease) that property by at least 20%, preferably by at least 15%, more preferably by at least 10%. Examples of useful diluents can include, but are not limited to, organic ethers such as propylene glycol monomethyl ether (PGME; e.g., sold under the tradename Dowanol® PM, commercially available from Dow), diethylene glycol monomethyl ether (DGME), diethylene glycol monobutyl ether (DGBE), and the like; hydroxy-functional solvents such as glycerol, ethanol, methanol, alkylene glycols such as ethylene glycol, propylene glycol, and polyethylene glycol, 1,2-hexanediol, 1,6-hexanediol, isopropanol, diacetone alcohol, and the like; dialkyl ketones such as acetone, methyl ethyl ketone, and the like; aromatics such as toluene, xylene, mesitylene, and the like; alkyl halides such as chloroform, bromoform, methylene chloride, methylene bromide, trichloromethane, and the like; and combinations thereof.

The optional diluent(s), as described herein, can be present in any amount sufficient to allow fabrication of the content access layer by techniques known in the art for depositing materials onto substrates. In one embodiment, the ink composition contains one or more diluents in a total amount ranging from about 30% to about 98% by weight, from about 45% to about 95% by weight, for example from about 70% to about 90% by weight.

The ink composition may also contain other additives to aid in processing. These may include dispersants such as Disperbyk™ (BYK-Chemi, USA), surfactants such as Surfynol™ (Air Products, USA), leveling agents, anti-foaming agents, viscosity modifiers, and the like, to improve various properties of the ink composition.

The amounts of the dye compound(s) and optional bleaching accelerant(s) can be greater, and the amount of optional diluent(s) can be lower, than the embodiments described above. For example, an increase in the amount of dye compound(s) to up to about 20% by weight or higher can become beneficial, especially when a high opacity is desired in the content access layer and/or when the number of exposures to the data reader system before the appropriate change in optical properties can be observed is desired to be more than the relatively small number discussed above.

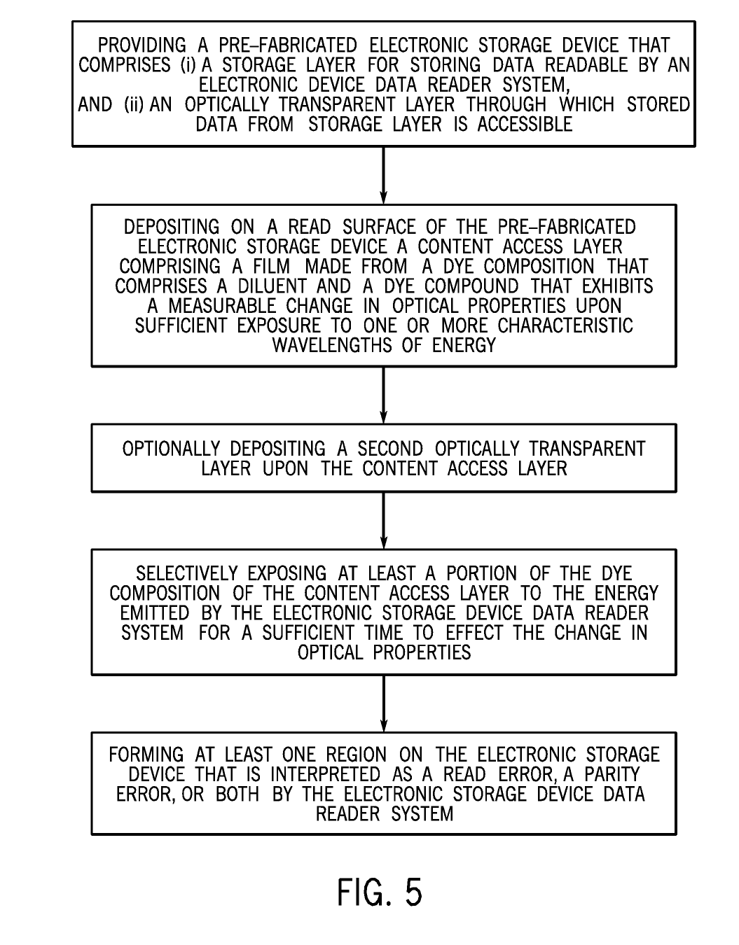

Another aspect of the technique relates to a method of fabricating a limited-use optical storage device, as described herein, for use with an optical storage device data reader system. In one embodiment, the method can include, but is not limited to, depositing on a read surface of pre-fabricated optical storage device 30, content access layer 14, as described herein, and optionally optically transparent (and protective) layer 12 upon content access layer 14. See, e.g., the flow chart of FIG. 5. The method also includes selectively exposing at least a portion of the ink composition of content access layer 14 to incident energy having one or more pre-selected wavelengths/frequencies for a sufficient time and at a sufficient intensity to effect a change in optical properties of the dye compound(s) in the exposed portion of the ink composition. This process can form at least one region on optical storage device 10 that is interpreted as a parity error and/or a read error by the optical storage device data reader system. The step of depositing content access layer 14 can be performed such that content access layer 14 is positioned between the optical storage device data reader system and storage layer 18 of pre-fabricated optical storage device 30 from which data is to be accessed, and typically proximal to another optically transparent layer 12, e.g., made from a polycarbonate material.

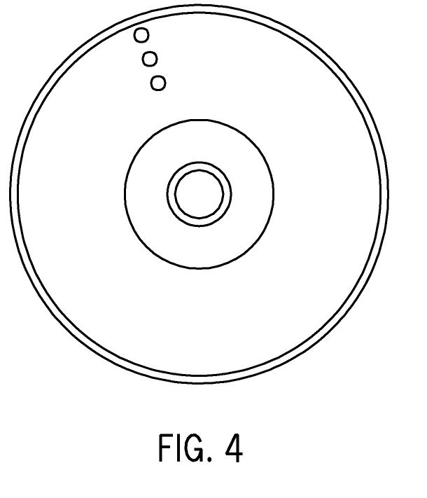

In an example, the selectively exposing step is accomplished by exposing content access layer 14 of optical storage device 10 to an energy source using a photomask tailored to obscure from the energy source the portion(s) of content access layer 14 where a change in optical properties are not desired and to allow exposure from the energy source to the portion(s) of content access layer 14 where a change in optical properties is desired. See, e.g., the photobleaching of all but three circular spots on the content access layer, as shown in FIG. 4. In such embodiments, the shape of the photomask can facilitate optical property changes in regions of any desired shape, e.g., circles, squares, astroids, rectangles, trapezoids, arcs, wedges, triangles, Reuleaux triangles, deltoids, cardioids, folia, nephroids, sectors, annuli, parallelograms, and the like, and combinations thereof.

The depositing of content access layer 14 (and optional second transparent/protective layer 12) is(are) achieved using a deposition process (or processes) that results in substantially no additional read errors. The term “additional read errors” means errors arising from the deposition process(es), which expressly does not include any read errors that were present, if any, in original pre-fabricated optical storage device 30 or that would have been present in the layers characteristic of a pre-fabricated optical storage device, e.g., without content access layer 14 and without optional second optically transparent layer 12, if present).

The depositing of content access layer 14 may be accomplished by a technique other than an ink-jet printing technique. On the other hand, the depositing of content access layer 14 may be achieved by spin coating the ink composition onto a read surface of pre-fabricated optical storage device 30. In another example, the depositing of content access layer 14 is achieved by spin coating the ink composition onto the entire read surface of pre-fabricated optical storage device 30.

In embodiments where the depositing of content access layer 14 is achieved by spin coating, a decreased amount of read errors (after bleaching) were observed for increased concentrations of dye compound(s), for spinning speeds that were relatively high, and for content access layer thicknesses that were relatively small (thin). Without being bound by theory, it is believed that increased dye compound concentration, increased spin speeds, and decreased layer thicknesses all positively affect the uniformity of the content access layer itself and/or of the dye compound dispersion amongst the content access layer.

If necessary or desired, after depositing content access layer 14 (but before depositing optional second transparent/protective layer 12, if present), any excess ink composition may be rinsed away with an appropriate solvent, e.g., the diluent(s) used in the ink composition, as described herein.

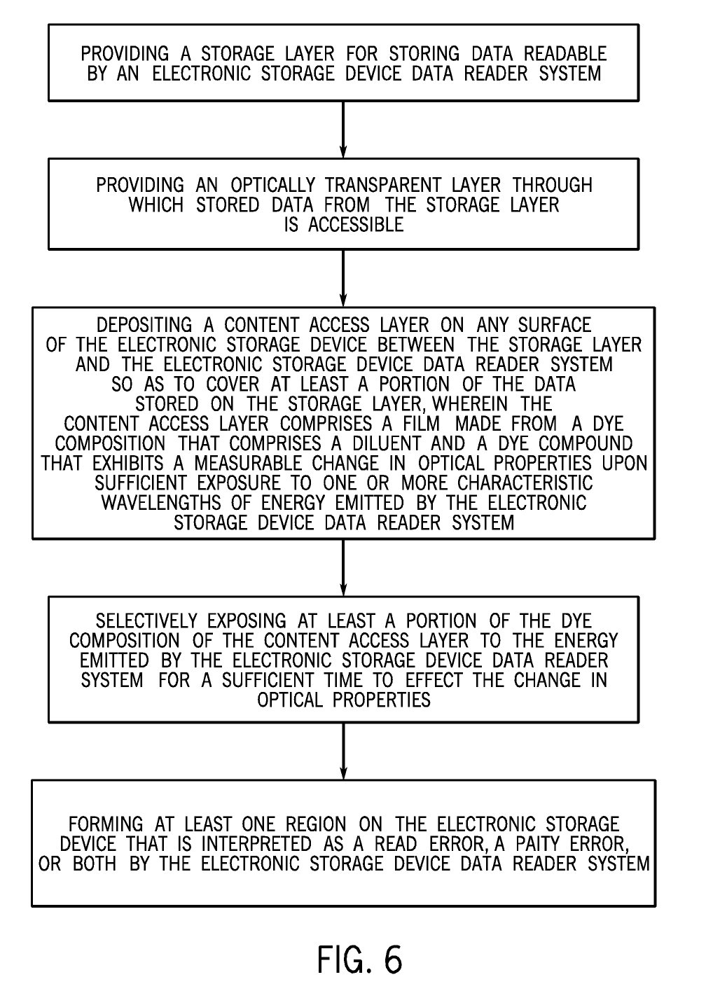

In another embodiment, the method can include, but is not limited to, the steps of: (i) providing optical storage device 30; (ii) depositing on optical storage device 30 content access layer 14, as described herein, between storage layer 18 and optically transparent layer 12 or 16; (iii) selectively exposing at least a portion of the ink composition of content access layer 14 to incident energy having one or more pre-selected wavelengths/frequencies for a sufficient time and at a sufficient intensity to effect a change in optical properties of the dye compound(s) in the exposed portion of the ink composition, and (iv) forming at least one region on optical storage device 30 that is interpreted as a read error and/or a parity error by the optical storage device data reader system. See, e.g., the flow chart of FIG. 6.

An example of a depositing process involves spin coating the ink compositions of content access layer 14 over an entire read surface of optical storage device 30. When the ink composition is originally colored and/or relatively opaque to a given wavelength of incident energy, subsequently one or more regions/spots are created by using a photomask to selectively bleach away the remainder of the color and/or opacity of the ink composition. In this embodiment, the one or more spots can cover specific regions of the storage layer. After one exposure or a predetermined number of (e.g., less than about 5) exposures to the energy emitted by the optical storage device data system reader, the transmissivity of content access layer 14 to the emitted energy should increase, allowing access to data on those specific regions of storage layer 18 that were previously inaccessible.

There are several ways in which to make data stored on storage layer 18 of limited-use content. In one embodiment, the one or more spots created can correspond to the area(s) of storage layer 18 on which one or more menus are stored. Upon a first or small number of initial plays of a DVD, for example, the menu(s) may be unreadable, causing the data reader system to indicate a read error, at which point the limited-use content, such as a trailer and/or advertisement, can be played without any choices by the user. However, after the initial number of plays of the DVD, when sufficient bleaching of the spots occurs, the menu(s) can be read and may give a user the ability to see the limited-use content again, if desired, or to skip the limited-use content entirely, if desired.

Alternately, the one or more spots created can be disposed over some specific area(s) of storage layer 18 that does not directly correspond to a menu or to any limited-use content. In this latter embodiment, upon noting a read error resulting from the unbleached ink composition, the DVD reader may be directed to a first portion of storage layer 18 on which the limited-use content data is stored. However, after the initial number of plays of the DVD, when sufficient bleaching of the spots occurs, the DVD reader may be directed to a second portion of storage layer 18, thus bypassing the limited-use content data. Thus, such a DVD may contain logic for detecting a change of optical state (or a change in read/parity error status) of the DVD and for directing the data reader system to the second portion of storage layer 18. A description of such logic, and a DVD containing such logic, can be found, for example, in U.S. Pat. No. 7,127,066, which is incorporated by reference in its entirety.

In the following examples, ink compositions were applied to the read-side (laser-incident surface, represented, for example, by the bottom of layer 16 in FIG. 1) of DVDs to form respective content access layers 14. Content access layers 14 contained dye compounds/compositions that were found to be more sensitive (faster rate of photobleaching) than those described in the prior art, e.g., the phthalocyanines or naphtholocyanines disclosed in U.S. Pat. No. 7,127,066.

Furthermore, the ink compositions were applied by various methods. In a preferred embodiment, the entire read surface of the DVD is spin-coated with the ink composition. Then regions of one or more spots are created by bleaching away undesired regions of dye with use of a photomask. This creates a variation of reflectivity in the coating while maintaining a uniform coating on the disc. It has been discovered that other deposition methods, e.g., ink-jet printing, screen printing, and pad printing are suitable methods for applying the ink to a substrate.

It should be noted that coating layers containing certain thiazines such as methylene blue, when exposed to light in the presence of organic amines such as triethanolamine, will bleach (turn from relatively opaque/colored to relatively transparent/colorless) relatively rapidly. However, upon removal of such a thiazine coating composition from the light source, the color of the dye will return (it will revert back to approximately its prior opacity/blue color) over a period of hours to days. This bleaching reversibility is undesirable in some embodiments. In contrast, it has also been discovered that, under similar conditions, cyanine dyes such as HNu640 are not similarly reversibly bleachable. In some embodiments, the method of accelerated development of photosensitive materials disclosed in U.S. Patent Application Publication No. 2004/0152127 A1, which is incorporated by reference in its entirety, can be used to evaluate dye compositions for content access layers, as described herein.

### EXEMPLARY DATA AND ANALYSIS

The following examples, exemplary data, and associated discussion are set forth to provide those of ordinary skill in the art with a detailed description of how the techniques claimed herein are evaluated, and are not intended to limit the scope of what the inventors regard as their invention.

As discussed, the present technique may relate to a limited-play optical article, such as a 1-play DVD. With this and other technologies, the present ink formulations may incorporate a photobleachable dye system dissolved or dispersed in a polymer matrix. The ink is printed in a spot or in a pattern of spots on the data side of the optical article, such as a DVD. When the DVD is played, the ink spots block the player's laser and prevent the player from reading the data underneath the ink spots. If the data underneath the ink spots can not be read, the DVD may be authored to play a certain set of content and to also position the laser so that is exposes the ink spots to 650 nm light. This light exposure initiates a chemical reaction in the ink, which bleaches the ink. On subsequent plays of the DVD, the bleached ink no longer prevents the DVD laser from reading the data that is positioned under the ink spots. In other words, after bleaching, the data underneath the ink spot is “uncovered” and the DVD is authored to skip a certain set of video content.

An aspect of present ink formulations may be a photobleachable ink that has the adequate sensitivity to bleach when exposed to 650 nm light inside a DVD player or DVD drive. The speed or rate at which the 1-play ink bleached may be dependent on the degree of drying (time and temperature) used to remove residual solvent from the ink after the ink is deposited on a DVD substrate.

Exemplary ink formulations of the present technique may include a cyanine dye and a borate, either as separate compounds or as a complex of their ions with each other. The borate or borate ion may act as a bleaching accelerant. The formulations may also include a polymer as a binder material. The formulations may also include a plasticizer to increase the bleach rate. Lastly, the formulations may typically include a solvent. Exemplary formulation combinations may include:

cyanine dye+polymer+solvent; (1)

cyanine dye+borate+polymer+solvent; (2)

cyanine dye+borate+polymer+plasticizer+solvent; (3)

complex of cyanine dye ion paired with borate ion+polymer+solvent; complex of cyanine dye ion paired with borate ion+borate+polymer+solvent; and (4)

complex of cyanine dye ion paired with borate+borate+polymer+plasticizer+solvent. (5)

The data in Table 1 show an exemplary effect of plasticization on the bleach rate of the ink. The composition of ink 1 is 24 mg HNu640 (complex of cyanine dye ion paired with borate), 52 mg of Borate V (borate), 80 mg of PMMA (360,000 mw), 1.34 g Dowanol DPM, 0.58 g diacetone alcohol. In each of these exemplary cases, the speed of bleaching was increased when inks were plasticized with residual solvent. It is believed that residual solvent in the wet inks plasticized the ink, allowing greater mobility of the components that react chemically to bleach the dye. The residual solvent eventually evaporates from the wet ink over time and the loss of plasticization from the solvent generally corresponds with a loss in bleach rate. Thus, it may be beneficial to plasticize the ink with a low-volatility plasticizer rather than a solvent to speed-up and maintain the faster bleach rate of the plasticized ink.

TABLE 1
Bleach rate of wet and dry ink (i.e. plasticized and unplasticized)

| | | bleach | |
|---|---|---|---|
| | Ink description | rate | stdev |
| 1 | Ink 1 (no drying) | 37 | 2 |
| 2 | Ink 1 (dried 1 hr at 80 C) | 10 | 1 |

In the testing to generate the data in

Table 1 the ink's bleach rate was measured after spin coating 10 microliters of ink 1 on the data side of a DVD at 3000 revolutions per minute (RPM). In the first case (row 1 of Table 1) the DVD spincoated with ink 1 was immediately exposed to a 650 nm laser beam [5 milliWatt (mW) optical power] without drying to remove residual solvent after spincoating and the percent reflectivity of the DVD coated ink spot was monitored at 650 nm. As the ink was bleached by the 650 nm laser, the percent reflectivity (measured at 650 nm) of the ink coated DVD increased. In the second case (row 2 of Table 1), the DVD spincoated with ink 1 was dried for 1 hour at 80° C. to remove any residual solvent left in the ink after spin coating. This sample was then exposed to the same 650 nm laser and the percent reflectivity of the DVD coated ink spot was monitored at 650 nm. As the ink was bleached by the 650 nm laser, the percent reflectivity (measured at 650 nm) of the ink coated DVD increased. It should be noted that percent reflectivity in the present examples was measured using an Ocean Optics UV-vis spectrophotometer employing a fiber-optic reflectance probe oriented normal to the optical storage medium. Percent reflectance is the measured value of light reflected off of optical storage medium according to Annex D in ECMA-267 specifications for DVD-Read-Only-Disk.

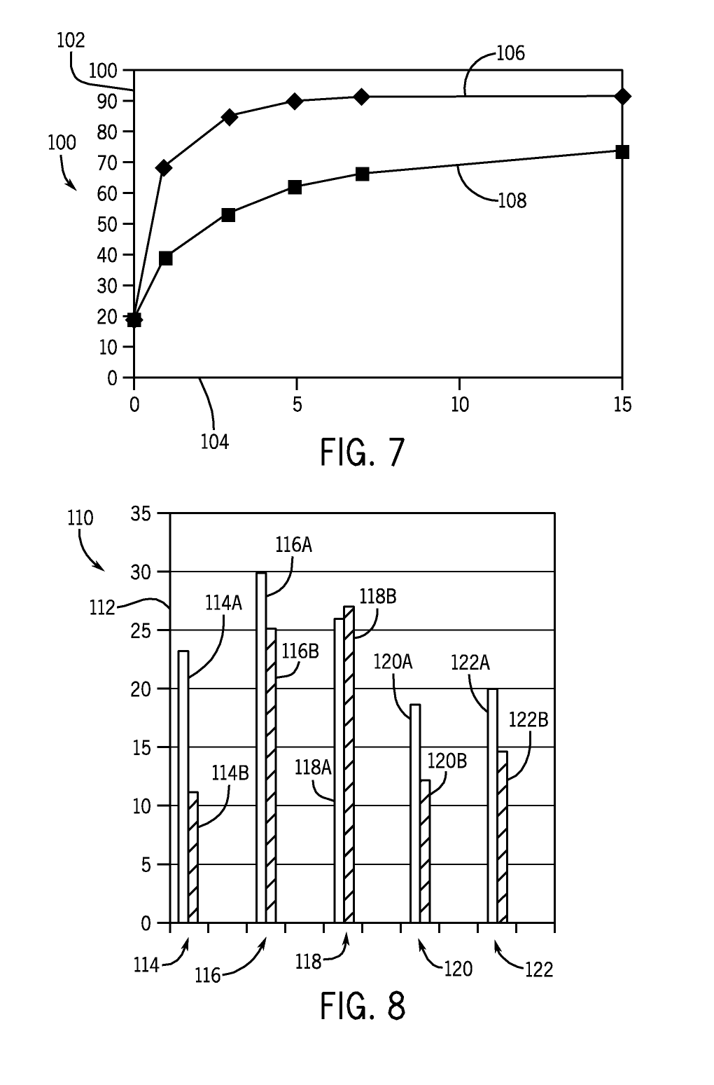

In this example, the bleach rate was determined based on the change in percent reflectivity over time of laser exposure. The differences in bleach rate between ink 1 with and without drying and un-plasticized ink is indicated by the plot 100 in FIG. 7. The percent reflectivity 102 of the DVD through the ink is plotted versus time 104 of laser exposure. The curve 106 for plasticized ink has a bleach rate (index) of 38. The curve 108 for un-plasticized ink has a bleach rate of 14. Thus, in this example, the bleach rate of ink 1 without drying (i.e. solvent plasticized ink) is 2.7 times faster than the ink after 1 hour drying at 80° C. un-plasticized ink.

Evaluation of bleach rate may involve monitoring the color and/or reflectivity of the deposited ink composition over time. In these examples, the bleach rate is the rate of change in reflectivity over time of exposure to the beam of a 650 nm laser.

The selection of a plasticizer to improve the ink's bleach rate in the present technique (e.g., 1-play DVD technology) may be based on identifying a material that: (1) improves and maintains a relatively fast bleach rate compared to an un-plasticized ink; and (2) maintains a substantially homogeneous ink composition that incorporates a dye system, polymeric matrix, and plasticizer, and so forth. The following examples illustrate several plasticized and unplasticized ink formulations that were evaluated. Exemplary structures are given in Appendix A.

Five inks were formulated based on the compositions in Table 2 to compare the bleach rate of four plasticized inks with un-plasticized ink. Screen printing was employed to print spots of these five inks on DVDs.

TABLE 2
Ink Formulations

| | Hnu-640 | Borate V | | DAA | Dowanol DPM | Plasticizer |
|---|---|---|---|---|---|---|
| Plasticizer name | (g) | (g) | PMMA, 1 MM mw (g) | (g) | (g) | (g) |
| None | 0.074 | 0.163 | 0.05 | 1.475 | 0.475 | 0 |
| Bis(2-ethylhexyl) phthalate | 0.074 | 0.163 | 0.05 | 1.475 | 0.475 | 0.016 |
| Bis[2-(2- | 0.074 | 0.163 | 0.05 | 1.475 | 0.475 | 0.016 |
| butoxyethoxy)ethyl] | | | | | | |
| adipate | | | | | | |
| Bis(3,4- | 0.074 | 0.163 | 0.05 | 1.475 | 0.475 | 0.016 |
| epoxycyclohexylmethyl) | | | | | | |
| adipate | | | | | | |
| poly(caprolactone) triol, | 0.074 | 0.163 | 0.05 | 1.475 | 0.475 | 0.016 |
| mw 300 | | | | | | |

The bleach rate of each ink formulation of Table 2 was measured at time zero (at the initial deposition on the DVD) and also after 350 hours of room-temperature aging (i.e., about 20° C.) of the DVD having the deposited ink. The results are presented in the bar chart 110 of FIG. 8, in which the bleach rate 112 is given for the five different ink compositions listed above:
114 no plasticizer;
116 (Bis(2-ethylhexyl) phthalate;
118 Bis[2-(2-butoxyethoxy)ethyl]adipate;
120 Bis(3,4-epoxycyclohexylmethyl)adipate; and
122 poly(caprolactone) triol, molecular weight of 300.

The bars of plot 110 are at no aging and at 350 hours of room-temperature aging, as indicated by reference letters A and B, respectively. The initial rate of the un-plasticized ink (at no aging) was 23 but fell to 11 after 350 hours at room temperature (114A and 114, respectively). The decrease in bleach rate was probably due to loss of residual solvent over this time period. In a sense, the initial rate of 23 was high because the residual solvent in the ink formulation may be acting as a plasticizer. In this example, the highest performing inks, based on both maintenance of bleach rate over time and homogeneity of the dry ink formulation were the inks that were plasticized with bis(2-ethylhexyl)phthalate and bis(2-(2-butoxylethoxyl)ethyl)adipate, as indicated by reference numerals 116, 116A, and 116B. 118. 118A and 118B.

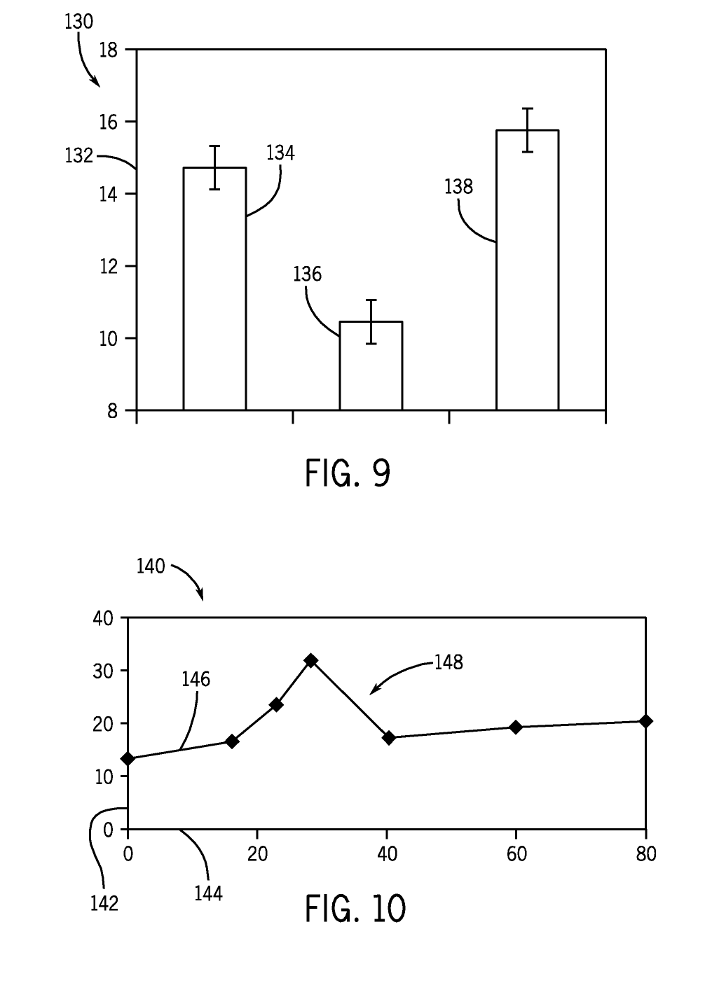

Plasticized inks for ink jet printing were evaluated. Three ink-jet inks were formulated based on the compositions in Table 3 to compare the performance of two plasticized inks with one un-plasticized ink. The bleach rate of these ink formulations are graphed in FIG. 9, which is a bar chart 130 of bleach rate 132 for the same ink formulations 134, 136, and 138 having poly(caprolactone) triol plasticizer (300 mw), no plasticizer, and epoxy adipate plasticizer, respectively.

TABLE 3
Ink-Jet Ink Compositions

| | | | | | Mass of | | Mass | Mass |
|---|---|---|---|---|---|---|---|---|
| | | | Masss of | Mass of | PMMA, | Mass of | of | of |
| | Plasticizer | Polymer | HNu640 | Borate | 37K mw | plasticizer | DPM | DAA |
| Reference | description | description | (g) | (g) | (g) | (g) | (g) | (g) |
| 134 | poly(caprolactone) | 37,000 Mw | 0.03 | 0.078 | 0.15 | 0.0375 | 1.352 | 1.352 |
| | triol (300 Mw) | PMMA | | | | | | |
| 136 | None | 37,000 Mw | 0.03 | 0.078 | 0.15 | 0.0000 | 1.371 | 1.371 |
| | | PMMA | | | | | | |
| 138 | Epoxy adipate | 37,000 Mw | 0.03 | 0.078 | 0.15 | 0.1500 | 1.296 | 1.296 |
| | | PMMA | | | | | | |

The plasticizer that performed best in this system was polycaprolactone triol. Again, the initial rate of the un-plasticized ink, in general, was fast relative to the same ink that was aged over a 9-day period at room temperature. The decrease in rate of this ink was probably due to the loss of residual solvent over time.

In another example, the effect of concentration of bis(2-ethylhexyl), also known as dioctyl phthalate (DOP), on bleach rate was evaluated. A series of ink formulations were prepared with increasing concentration of DOP. The ink formulations are listed in Table 4. Exemplary results are given in FIG. 10 which is a plot 140 of bleach rate 142 versus DOP concentration 144 in weight percent based on the mass of polymer in the ink formulation. Curve 146 depicts a beneficial DOP concentration of about 25 wt % DOP based on the mass of polymer. At higher concentrations, the ink may begin to phase separate, as indicated by reference numeral 148. This has a positive effect on rate at 28 wt % DOP but as phase separation increases at 40 to 80 wt % DOP the bleach rate decreased.

TABLE 4
Ink Formulations with Increasing DOP Concentration.

| | Masss of | Mass of | | | | | | | |
|---|---|---|---|---|---|---|---|---|---|
| | HNu640 | Borate V | Mass of | Mass of | Mass of | Mass of | | | |
| | (g) | (g) | DOP (g) | PMMA (g) | DAA (g) | DPM (g) | avg rate | stdev | Description |
| 1 | 0.0600 | 0.1300 | 0.0000 | 0.2500 | 2.2800 | 2.2800 | 13.67 | 0.58 | control |
| 2 | 0.012 | 0.026 | 0.01 | 0.05 | 0.456 | 0.456 | 16.67 | 0.58 | 16% DOP |
| 3 | 0.012 | 0.026 | 0.015 | 0.05 | 0.456 | 0.456 | 23.67 | 0.58 | 23% DOP |
| 4 | 0.012 | 0.026 | 0.02 | 0.05 | 0.456 | 0.456 | 32.00 | 1.00 | 28% DOP |
| 5 | 0.012 | 0.026 | 0.0333 | 0.05 | 0.456 | 0.456 | 17.33 | 1.15 | 40% DOP |
| 6 | 0.012 | 0.026 | 0.0750 | 0.05 | 0.456 | 0.456 | 19.33 | 1.15 | 60% DOP |
| 7 | 0.012 | 0.026 | 0.2000 | 0.05 | 0.456 | 0.456 | 20.33 | 4.93 | 80% DOP |

In yet another example, the effect of borate concentration on bleach rate was evaluated. HNu-640 blue dye that can be used as a photoinitiator for free radical polymerization. When HNu640 is irradiated with visible light in the 650 nm range it is bleached from blue to light yellow. The dye is generally employed in the present technique not to initiate a polymerization reaction but rather to create a blue to colorless (yellow) transition upon exposure to 650 nm light. The mechanism for initiating a free radical polymerization with HNu-640 dye as described in J. Am. Chem. Soc., 112, 6329-38 (1990) can be accelerated by the use of appropriate electron transfer agent agents such as salts of triphenyl butyl borate. HNu-640 is a cationic dye that is ion paired with a triphenylbutyl borate anion. The bleach rate of HNu-640 can be increased by the addition of triphenyl butyl borate salts such as Borate V or similar salts of diphenyldialkyl borates. See Appendix A for the structures and chemical compositions of HNu-640 and Borate V.

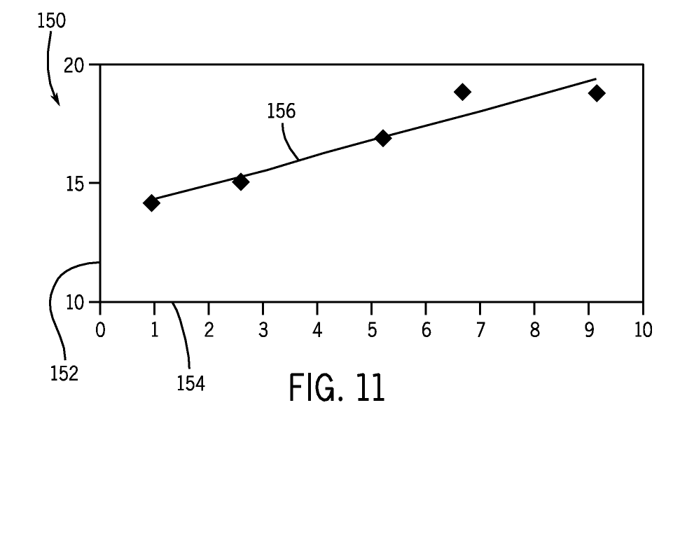

The data in Table 5 lists the bleach rate for HNu-640 as a function of triphenyl butyl borate concentration. Dye 683 has the same chemical structure as the cationic portion of HNu-640 but with a perchlorate anion in place of the triphenyl butyl borate anion in HNu-640. Therefore, dye 683 can be used to show the increase in bleach rate when the perchlorate anion is exchanged with triphenylbutyl borate anion. Exemplary results are tabulated in Table 5 and plotted in FIG. 11. FIG. 11 is a plot 150 of bleach rate 153 versus the mole ratio 154 of Borate V to HNu-640. Curve 156 shows and increasing bleach rate 152 as a function of increasing amounts of Borate V.

TABLE 5
Bleach Rate vs. Triphenyl Butyl Borate Concentration

| | | | Mass of | | | | Mass of | | |
|---|---|---|---|---|---|---|---|---|---|
| | Mass of | Mass of | PMMA, | | | | poly(caprolactone | Borate: | Bleach |
| | HNu640 | Borate V | 37,000 mw | Mass of | Mass of | Mass of | triol) Mw = 300 | Dye mole | rate |
| NB # | (g) | (g) | (g) | PCLT (g) | DPM | DAA | (g) | ratio | (units) |
| 1 | 0.01 | 0.0500 | 0.0500 | 0.0125 | 0.43875 | 0.43875 | 0.0125 | 9.1 | 19 |
| 2 | 0.01 | 0.0350 | 0.0500 | 0.0125 | 0.44625 | 0.44625 | 0.0125 | 6.7 | 19 |
| 3 | 0.01 | 0.0260 | 0.0500 | 0.0125 | 0.45075 | 0.45075 | 0.0125 | 5.2 | 17 |
| 4 | 0.01 | 0.0100 | 0.0500 | 0.0125 | 0.45875 | 0.45875 | 0.0125 | 2.6 | 15 |
| 5 | 0.01 | 0.0000 | 0.0500 | 0.0125 | 0.46375 | 0.46375 | 0.0125 | 1.0 | 14 |

In yet another example the bleach rate of two different sets of inks measured with and without the addition of a borate bleaching accelerant. The inks were spin coated on DVDs and the bleach rate was measured by exposing the dry ink films to the beam of a 650 nm laser. The bleach rate of the ink films is reported as the change in reflectivity per second. Exemplary results are tabulated in Table 6. The results indicate that the addition of Borate V bleaching accelerant (see appendix A for chemical structure) to the ink formulation results in faster bleaching of the ink coating. In the ink that contained dye 683, the bleach rate without Borate V bleaching accelerant was 0% R/sec. compared to a rate of 0.1% R/sec. with Borate V. In the second set of inks, which contained brilliant green dye, the bleach rate without Borate V was 0 compared to 0.3 with Borate V. In the third set of inks, which contained 2,4,5,7-tetraiodo-9-cyano-3-hydroxyxanthen-6-one (H-Nu 635, Spectragroup, USA) the bleach rate without Borate V was 0.03 compared to 0.72 with Borate V.

TABLE 6
Bleach Rate as Change in Percent Reflectivity per Second

| | | | | | Wt % | Change in % |
|---|---|---|---|---|---|---|
| | | | Wt % | Wt % | PMMA | reflectivity |
| | Dye | Dye class | dye | Borate V | (37K Mw) | per second |
| 1 | Dye 683 | cyanine | 0.8 | 2.6 | 5.0 | 0.10 |
| 2 | Dye 683 | cyanine | 0.8 | 0.0 | 5.0 | 0.00 |
| 3 | brilliant | triaryl | 1.6 | 2.6 | 5.0 | 0.30 |
| | green | methane | | | | |
| 4 | brilliant | triaryl | 1.6 | 0.0 | 5.0 | 0.00 |
| | green | methane | | | | |
| 5 | HNu635 | xanthene | 0.5 | 3.0 | 10.0 | 0.03 |
| 6 | HNu635 | xanthene | 0.5 | 0.0 | 10.0 | 0.72 |

Several classes of plasticizers could be used to plasticize and improve the bleach rate of the photo-bleachable ink formulations. For example, Table 7 contains a list of plasticizers from The Handbook of Plasticizers that are compatible with PMMA

TABLE 7
Examples of plasticizers compatible with PMMA

| Plasticizer Class | Specific example(s) |
|---|---|
| Adipates | Main alcohols used in commercial products: 2- |
| | ethylhexyl, butyl, butoxyethyl, heptyl, isobutyl, |
| | isodecyl, isononyl, methyl, tridecyl |
| Phosphates | Main alcohols used in commercial products: |
| | isopropanol, butanol, butoxyethanol, 2-ethylhexyl, |
| | isodecyl, phenol, cresol, xylenol, 2-chloroethanol |
| Phthalates | Main alcohols used in commercial products: |
| | methyl, ethyl, butyl, isobutyl, hexyl, cyclohexyl, |
| | heptyl, octyl, 2-ethylhexyl, 1-methylheptyl, |
| | butoxycarbonylmethyl, nonyl, isononyl, decyl, |
| | isodecyl, undecyl, tridecyl, benzyl, mixtures of |
| | alcohols (e.g., C7 to C9 or C9 to C11, etc.), 2,2,4- |
| | trimethyl-1,3-pentanediol-1-isobutyrate |
| Sebacates | Main alcohols used in commercial products: |
| | butoxyethanol, butyl, 2-ethylhexyl |
| Tri and | Main alcohols used in commercial products: 2- |
| pyromellitates | ethylhexyl, 2-propenyl, C7 to C9, C8 to C10, nonyl |

The solvents in the aforementioned ink formulations maybe appropriately selected to satisfy various criteria. For example, considered was sufficient solubility of the polymer matrix, e.g. poly(methyl methacrylate), the dye, and other additives in the ink formulation. The solubility of the different components in the solvents should be similar to avoid any phase separation during the post-deposition drying step.

Another consideration is inertness towards the polycarbonate material of the DVD, so that the solvents do not induce solubilization, crystallization or any other form of chemical or physical attack of the polycarbonate. This is beneficial to preserve the readability of the data underneath the spots. For the same reason, in the case of solvent mixtures, the volume fraction of the solvent that can potentially attack the polycarbonate should to be less than 30%, for example.

Moreover, low vapor pressure and high boiling points (at least 115° C. in some examples) of the solvent may be beneficial so that the inks are readily screen printable or inkjet printable. Solvents with lower boiling points may evaporate rapidly from the ink and cause clogging of the printhead nozzles in the case of inkjet printing and cause on-screen drying in the case of screen printing, for example, leading to poor quality spots. Another factor may be the non-reactivity with the components of the ink. Appropriate surface tension of the solvent for printability on a polycarbonate surface may also be a consideration

In many of the embodiments, the solvents chosen for the ink, that satisfied substantially all of the above criteria discussed include diacetone alcohol and certain glycol ethers. In one example, the solvent is of a mixture of diacetone alcohol and dipropylene glycol methyl ether, also known as Dowanol DPM. In another example, the solvent is a mixture of diacetone alcohol and butyl carbitol. In yet another example, the solvent is of a mixture of Dowanol DPM and butyl carbitol. In yet another example, the solvent is of a mixture of Dowanol DPM, Dowanol PM, and diacetone alcohol.

Exemplary formulations of the present technique for ink jet printing are given in Table 8 and for screen printing are given in Table 9.

TABLE 8
Exemplary Formulations for Ink Jet Printing

| Dye component | Lower Wt % | Higher Wt % | Average Wt % |
|---|---|---|---|
| HNu-640 | 0.6 | 1.6 | 1.2 |
| Borate V | 1 | 4 | 2.6 |
| PMMA (37K mw) | 3 | 10 | 5 |
| bis(2-ethylhexyl) phthalate | 0.1 | 5 | 1 |
| Dowanol DPM (DPM) | 10 | 85 | 45.1 |
| diacetone alcohol | 10 | 85 | 45.1 |

TABLE 9
Exemplary Formulations for Screen Printing

| Dye component | Lower Wt % | Higher Wt % | Average Wt % |
|---|---|---|---|
| HNu-640 | 0.6 | 1.6 | 1.2 |
| Borate V | 1 | 4 | 2.6 |
| PMMA (1 MM mw) | 3 | 10 | 5 |
| bis(2-ethylhexyl) phthalate | 0.1 | 5 | 1 |
| Dowanol DPM (DPM) | 10 | 85 | 45.1 |
| diacetone alcohol | 10 | 85 | 45.1 |

### APPENDIX A: CHEMICAL STRUCTURES OF INK COMPONENTS

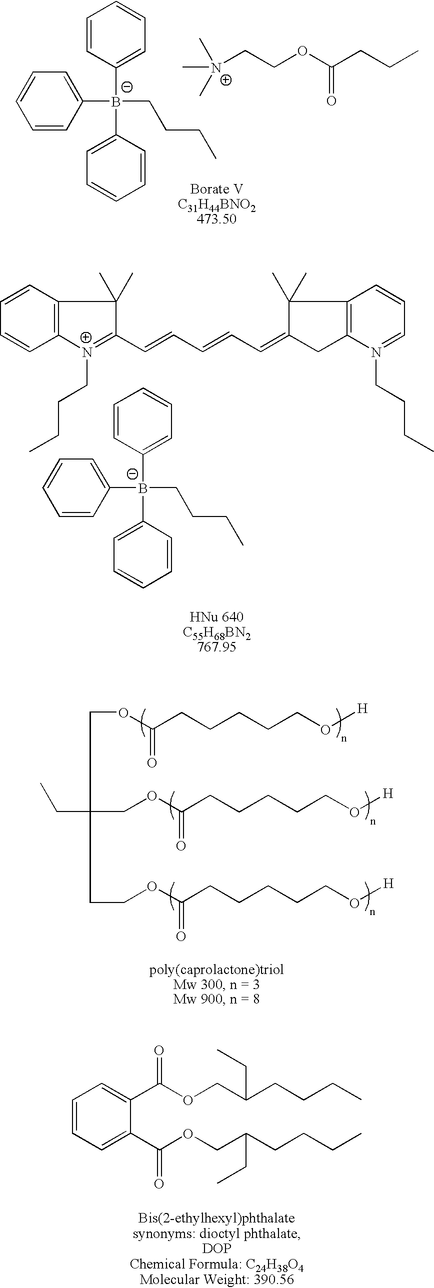

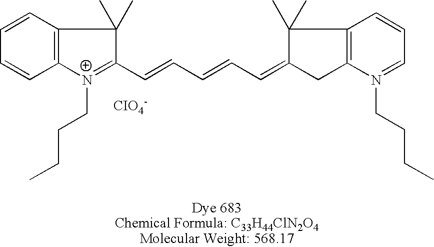

1. A photobleachable ink composition comprising:
at least one light-sensitive optical-state change material;
at least one bleaching accelerant;
at least one solvent;
and at least one binder material; wherein the ink composition has a viscosity between about 0.1 centipoise and about 10,000 centipoise, and a maximum optical absorbance in a range from about 200 nanometers to about 800 nanometers; and wherein the ink composition is capable of change from a first optical state to a second optical state upon exposure to light.

2. The composition of claim 1, wherein the optical-state change material comprises an organic dye with absorption between about 200 nm and 800 nm.

3. The composition of claim 1, wherein the optical-state change material comprises a polymethine dye, triarylmethane dye, xanthene dye, thiazine dye, oxazinedye, lactone dye, fulgide dye, spiropyran dye, or diarylethene dye, or any combination thereof.

4. The composition of claim 1, wherein the optical-state change material comprises a cyanine dye.

5. The composition of claim 1, wherein the bleaching accelerant comprises an electron donating agent.

6. The composition of claim 1, wherein the bleaching accelerant comprises a trifunctional amine, a difunctional amine, a monofunctional amine, a borate salt, or an iodonium salt, or any combination thereof.

7. The composition of claim 1, wherein the bleaching accelerant comprises a borate anion with a structure of 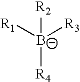
where R1, R2, R3, and R4 independently represent alkyl, aryl, alkaryl, allyl, aralkyl, alkenyl, alkynyl, silyl, alicyclic or saturated or unsaturated heterocyclic group.

8. The composition of claim 1, wherein the bleaching accelerant 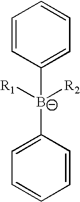
comprises the anion
where R1 and R2 are independently hydrogen or alkyl groups containing from 1-16 carbons.

9. The composition of claim 8, wherein a cation associated with the bleaching accelerant comprises butyrlcholine.

10. The composition of claim 1, wherein the bleaching accelerant
comprises the anion 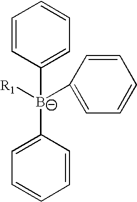
where R1 is hydrogen or an alkyl groups containing from 1-16 carbons.

11. The composition of claim 10, wherein a cation associated with the bleaching accelerant comprises butyrlcholine.

12. The composition of claim 1, comprising a plasticizer.

13. The composition of claim 12, wherein the plasticizer comprises an organic plasticizer.

14. The composition of claim 13, wherein the organic plasticizer comprises a phthalate, phosphate, sebacate, trimellitate, pyromellitate, or adipate, or any combination thereof.

15. The composition of claim 13, wherein the organic plasticizer comprises dioctyl phthalate, diethylhexylphthalate, or polycaprolactone triol, or any combination thereof.

16. The composition of claim 1, wherein a change in optical absorbance from the first optical state to the second optical state is greater than 10 percent.

17. The composition of claim 16, wherein the change is substantially irreversible

18. A photosensitive ink composition comprising:
at least one photosensitive optical-state change material;
at least one additive for accelerating bleaching;
at least one solvent; and
at least one binder material;
wherein the phtosensitive ink composition comprises a viscosity between about 0.1 centipoise and about 10,000 centipoise, and a maximum optical absorbance in a range from about 200 nanometers to about 800 nanometers, and wherein the phtosensitive ink composition is capable of transforming from a first optical state to a second optical state upon exposure to an optical stimulus.

19. The composition of claim 18, comprising at least one plasticizer, and wherein the photosensitive optical-state change material comprises at least one dye.

20. The composition of claim 18, wherein the additive or accelerating bleaching comprises a borate anion with a structure of 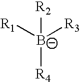
where R1, R2, R3, and R4 independently represent alkyl, aryl, alkaryl, allyl, aralkyl, alkenyl, alkynyl, silyl, alicyclic, or saturate or unsaturated heterocyclic group, or a combination thereof.

21. The composition of claim 18, wherein the at least one solvent comprises a glycol ether solvent, an aromatic hydrocarbon solvent containing at least 7 carbon atoms, an aliphatic hydrocarbon solvent containing at least 6 carbon atoms, a halogenated solvent, an amine based solvent, an amide based solvent, a oxygenated hydrocarbon solvent, or any miscible combination thereof.

22. The composition of claim 18, wherein the binder material comprises a polymer, an oligomer, a polymeric precursor, or a polymerizable monomer, or any combination thereof.

23. The composition of claim 18, wherein the binder material comprises a polyolefin, a polyester, a polyamide, a polyacrylate, a polymethacrylate, a polymethylmethacrylate (PMMA), a polyvinylchloride, a polycarbonate, a polysulfone, a polysiloxane, a polyetherimide, a polyetherketone, a copolymer thereof, or any combination thereof.

24. The composition of claim 18, wherein the binder material comprises PMMA having a molecular weight in the range of 5,000 to 2,000,000.

25. The composition of claim 18, wherein the photosensitive ink composition is transformed from the first optical state to the second optical state by exposure to a 650 nm laser in a DVD player.

26. The composition of claim 18, wherein the difference in optical absorbance of the photosensitive ink composition between the first optical state and the second optical state is at least 10 percent.

27. A light-sensitive coating deposited using a light-sensitive ink composition, wherein the coating comprises:
at least one light-sensitive optical-state change material;
at least one bleaching accelerant; and
at least one binder material; wherein the light-sensitive coating is essentially free of solvent and has a maximum optical absorbance in a range from about 200 nanometers to about 800 nanometers, and wherein the light-sensitive coating is capable of transforming from a first optical state to a second optical state upon exposure to light.

28. The coating of claim 27, wherein the photosensitive optical-state change material comprises at least one dye.

29. The coating of claim 27, comprising at least one plasticizer.

30. An article comprising a photosensitive coating composition deposited in or deposited on the article, wherein the photosensitive coating composition comprises at least one photosensitive optical-state change material, at least one additive for accelerating the bleaching, at least one binder material, and optionally at least one plasticizer, wherein the photosensitive coating composition is substantially free of solvent, wherein the photosensitive coating composition has an optical absorbance in a range from about 200 nanometers to about 800 nanometers, and wherein the photosensitive coating is capable of transforming from a first optical state to a second optical state upon exposure to a light stimulus.

31. The article of claim 30, wherein the optical article comprises a CD, a DVD, a HD-DVD, a blu-ray disc, a near field optical storage disc, or a holographic storage medium.

32. The article of claim 30, wherein the composition is deposited in a discrete area of the optical article, a continuous layer extending across a portion of the optical article, or a patterned layer extending across a portion of the optical article.

33. The article of claim 30, further comprising a second layer deposited on the photosensitive coating composition.

34. An optical storage device on which at least some limited-use data is stored, comprising:
a storage layer for storing data readable by an optical storage device data reader system;
a content access layer covering at least a portion of the data stored on the storage layer and comprising an ink composition comprising a dye compound, wherein the ink composition exhibits a measurable change in optical properties in less than about 10 seconds of exposure to a light source emitting wavelengths from about 200 nm to about 800 nm at an intensity from about 0.5 mW to about 50 mW; and
an optically transparent layer through which stored data from the storage layer is accessible.

35. The optical storage device of claim 34, wherein the content access layer comprises an bleaching agent.

36. The optical storage device of claim 34, wherein the bleaching agent comprises a borate anion with a structure of 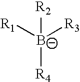
where R1, R2, R3, and R4 independently represent alkyl, aryl, alkaryl, allyl, aralkyl, alkenyl, alkynyl, silyl, alicyclic or saturate or unsaturated heterocyclic group.or a combination thereof.

37. The optical storage device of claim 34, wherein the dye compound comprises a polymethine dye.

38. An optical storage device, on which at least some limited-use data is stored, comprising:
a storage layer for storing data readable by an optical storage device data reader system;
a content access layer covering at least a portion of the data stored on the storage layer, wherein the content access layer comprises a polymethine dye an bleaching agent, and a binder, wherein the polymethine dye exhibits a measurable change in optical properties upon sufficient exposure to one or more characteristic wavelengths of energy; and
an optically transparent layer through which stored data from the storage layer is accessible.

39. The optical storage device of claim 38, wherein the polymethine dye comprises a cyanine.

40. The optical storage device of claim 38, wherein the bleaching agent comprises a borate anion with a structure of 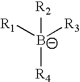
where R1, R2, R3, and R4 independently represent alkyl, aryl, alkaryl, allyl, aralkyl, alkenyl, alkynyl, silyl, alicyclic or saturate or unsaturated heterocyclic group.or a combination thereof.

41. The optical storage device of claim 38, wherein the content access layer comprises a binder and a plasticizer.

42. A method of fabricating a limited-use optical storage device, comprising:
depositing a photobleachable ink composition comprising at least one light-sensitive optical-state change material, at least one bleaching agent, at least one solvent, and at least one binder material; wherein the ink composition has a viscosity between about 0.1 centipoise and about 10,000 centipoise, and a maximum optical absorbance in a range from about 200 nanometers to about 800 nanometers, and wherein the ink composition is capable of transforming from a first optical state to a second optical state upon exposure to light.

43. The method of claim 42, wherein the ink composition comprises a plasticizer.

44. The method of claim 43, wherein the plasticizer increases a bleach rate of the ink composition.

45. The method of claim 42, wherein the optical-state change material comprises a polymethine dye.

46. The method of claim 42, wherein the change in optical reflectivity from the first optical state to the second optical state is greater than 10 percent.
